(19) United States
(12) Patent Application Publication
(10) Pub. No.: US 2009/0322647 A1
(43) Pub. Date: Dec. 31, 2009

(54) Articulating dual antenna

(76) Inventors: Michael Joseph Shawver, Pleasanton, CA (US); Jesse Arnold Fourt, Shanghai (CN); James R. Yurchenco, Palo Alto, CA (US); David Carl Thomsen, San Mateo, CA (US); Eric Andrew Dorsey, Palo Alto, CA (US)

Correspondence Address: Robert D. Shedd, Patent Operations;THOMSON Licensing LLC, P.O. Box 5312, Princeton, NJ, 08543-5312, US

(21) Appl. No.: 11/990,810

(22) PCT Filed: Aug. 23, 2006
(86) PCT No.: PCT/US06/33127

§ 371 Date: Apr. 27, 2009

Related U.S. Application Data
(60) Provisional application No. 60/710,940, filed on Aug. 24, 2005.

(51) Int. Cl. H01Q 3/02

(52) U.S. Cl. 343/882

(57) ABSTRACT

A method and apparatus for deploying a multi-element antenna system on a portable television signal processing apparatus. The system utilizes a plurality of spring loaded racks engaged in a pinion restrained by a rotational damper and a manual release mechanism. Each individual rack is attached to a rotational mechanism used to rotate an antenna element around an axis. The springs are compressed when the antenna is in its stored state and released via the manual release mechanism. The released rack and pinion system biases a plurality of rotational mechanisms which respectively extend the antenna elements into their deployed configuration.

### PRIORITY CLAIM

This application claims the benefit of U.S. Provisional Patent Application No. 60/710,940, filed Aug. 24, 2005, entitled “ARTICULATING DUAL ANTENNA” which is incorporated herein by reference.

### FIELD OF THE INVENTION

The present invention relates to antenna systems for portable electronic devices, and particularly to deployable antenna system for a portable television signal processing device.

### BACKGROUND OF THE INVENTION

Portable television signal processing devices, such as handheld portable televisions and portable radio receivers are quite ubiquitous and the antenna systems for these devices are well known. However, as more of these portable devices are being designed to receive digital signals, the performance of the antenna system becomes more critical and complex. Often these antennas must be more efficient that their analog counterparts, polarization of the incoming signal must be more carefully considered, and effects such as ghosting and multipath become more detrimental.

Antennas on portable devices are often subjected to rough handling. Retracting the antenna into a position where it is less vulnerable to damage during transportation is desirable. Retracted antennas may be stored in a smaller volume in their retracted state than in their deployed configuration. Therefore, it is desirable to have an antenna system which can be easily deployable into its optimum operating configuration, but easily stored for protection and reduction of volume during transport.

### SUMMARY OF THE INVENTION

In one aspect, the present invention involves method and apparatus for deploying a multi-element antenna system on a portable television signal processing apparatus. The system utilizes springs and a rotational damper to bias a rack and pinion system. Each individual rack is attached to a rotational mechanism used to rotate an antenna element around an axis. The springs are compressed when the antenna is in its stored state and released via a manual release mechanism. The released spring loaded rack and pinion system extends the antenna elements into their deployed configuration.

In another aspect, the invention further comprises a power switch with an on state and an off state. The system utilizes springs and a rotational damper to bias a rack and pinion system. The released springs extend the racks of the rack and pinion system which in turn biases a rotational mechanism used to rotate an antenna element around an axis. The rotational mechanism is further configured to change the state of the power switch when rotational damper extends the antenna elements into their deployed configuration. Manually retracting the antenna elements reverses the direction of the rotational mechanism, thereby changing the state of the power switch.

### BRIEF DESCRIPTION OF THE DRAWINGS

FIG. 1 shows an exemplary embodiment of an antenna system in a retracted state according to the present invention.

FIG. 2 shows an exemplary embodiment of an antenna system in a deployed state according to the present invention.

FIG. 3 shows a cutaway view of an exemplary embodiment of an antenna deployment mechanism according to the present invention.

FIG. 4 shows a cutaway view of an exemplary embodiment of an antenna deployment mechanism according to the present invention.

FIG. 5 shows a cutaway view of an exemplary embodiment of a release mechanism for antenna deployment according to the present invention.

### DETAILED DESCRIPTION OF THE PREFERRED EMBODIMENT

A preferred embodiment of the present invention teaches a system employing two electrically independent antennas which are mechanically coupled by a rack and pinion system which constrains them to synchronized motion. Springs preload the system, always biasing the antennas toward their deployed or “up” position. A rotary damper controls the speed at which the antennas are driven, to maintain a slow and smooth motion. Pushing one or both antennas down latches the system closed, with both antennas folded. Until the actuation button is pressed, the system is held in the latched position because the spring-loaded button prevents the pinion from rotating. The button has smooth actuation because it is contacted by a lubricious button plunger on the tip of the button spring. When the button is depressed, overcoming the button spring, the button catch is moved clear of the pinion, permitting the system to be driven open by the antenna springs.

An additional feature of the preferred embodiment is that one of the antennas may activate a power switch on the device. Activating the antenna button deploys the antennas, which turns on the device. Folding the antennas may turn the product off by releasing the power switch.

While the exemplary embodiment describes a system with two electrically isolated antennas, each having a single element, one skilled in the art will recognize that the current invention will be equally effective with a single, multi-element antenna, such a dipole antenna.

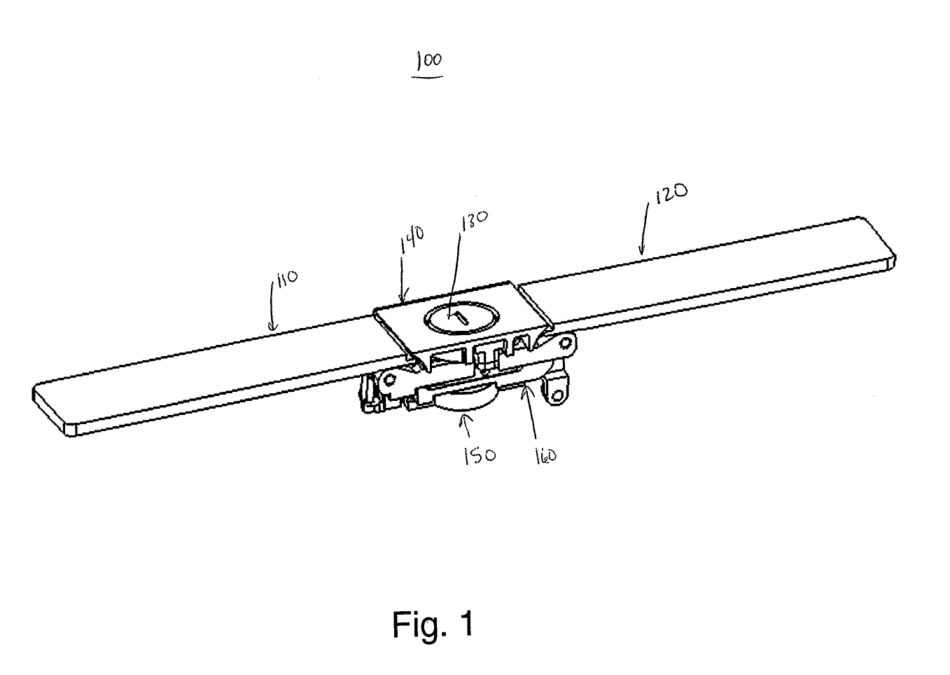

Referring to FIG. 1, an exemplary embodiment of an antenna system (100) in a retracted state according to the present invention is shown. FIG. 1 shows a first antenna element (110), a second antenna element (120), an actuation button (130), a frame (140), a rotary damper (150) and a first rack (160).

FIG. 1 depicts the antenna system (100), comprising a first antenna element (110) and a second antenna element (120) in a retracted configuration. An exemplary use of the antenna system (100) in a portable television device would have the antenna system (100) mounted within the portable television device enclosure such that the top surfaces of the antenna elements (110, 120) and the frame (140) are flush with the enclosure (not shown). The antenna system (100) would therefore be protected within the enclosure during transport of the device.

In the retracted configuration, a first spring and a second spring (not shown) are held in a compressed state, compressed by a first rack and a second rack (not shown). The racks are kept from rotating by a pinion (not shown), which is attached to the rotary damper (150). The actuation button (130), until depressed, will hold the system in the latched position because the spring-loaded button prevents the pinion from rotating.

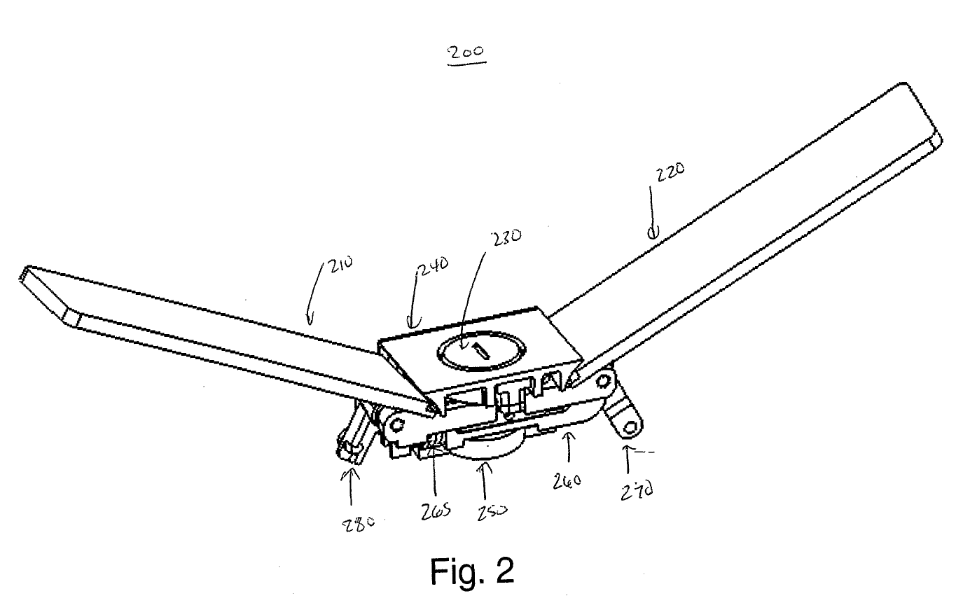

Referring to FIG. 2, an exemplary embodiment of an antenna system (200) in a deployed state according to the present invention is shown. FIG. 2 shows a first antenna element (210), a second antenna element (220), an actuation button (230), a frame (240), a rotary damper (250), a first rack (260), a first spring (265), a first rotational mechanism (270) and a second rotational mechanism (280).

FIG. 2 depicts the antenna system (200) in the deployed configuration. Until the actuation button is pressed, the system is held in the latched position because the spring-loaded button prevents the pinion from rotating. Once the actuation button (230) is depressed, the antenna elements (210, 220) are rotated around the first rotational mechanism (270) and the second rotational mechanism (280) respectively. The actuation button (230) has smooth actuation because it is contacted by a lubricious button plunger on the tip of the button spring. When the button is depressed, overcoming the button spring, the button catch is moved clear of the pinion, permitting the system to be driven open by the antenna springs.

When the antenna assembly (200) is in the deployed configuration, the frame (240) remains flush with the device enclosure (not shown). However, the first and second antenna elements are rotated to their predetermined operating configuration, out of the recessed portions of the device enclosure which protect the antenna elements when the device is not in use. The speed at which the antenna elements are rotated is controlled by the rotary damper (250). The rotary damper (250) controls the rotational speed of the pinion (not shown). The pinion control the speed at which the first rack (260) and a second rack (not shown) are biased by a first spring (265) and a second spring (not shown). The first and second rack (260), in turn, bias the first and second rotational mechanisms (270, 280), which rotate the first and second antenna elements (210, 220) around the first and second axis' respectively.

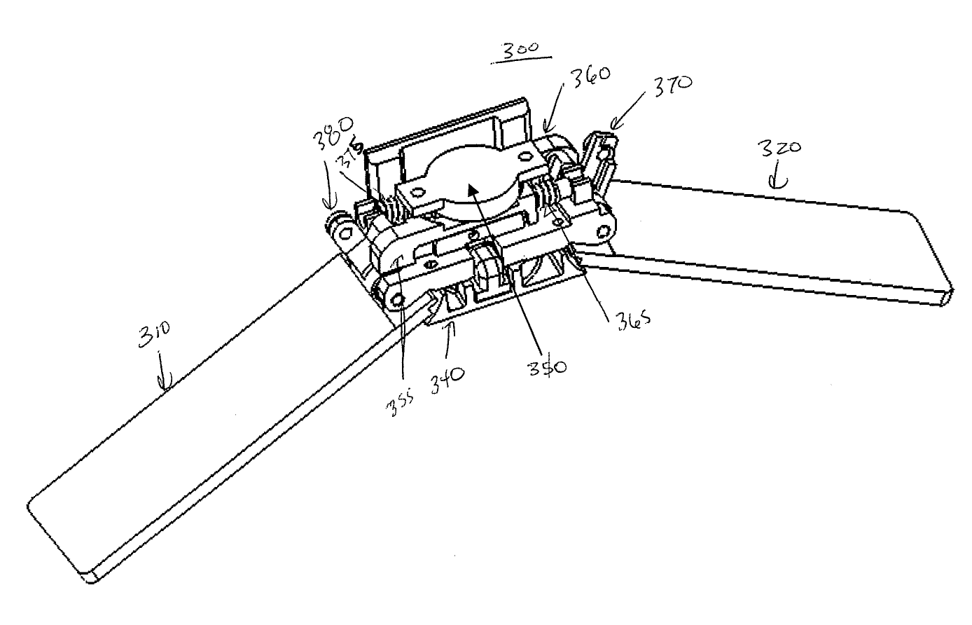

Referring to FIG. 3, a cutaway view of an exemplary embodiment of an antenna deployment mechanism (300) according to the present invention is shown. FIG. 3 shows a first antenna element (310), a second antenna element (320), a frame (340), a rotary damper (350), a first rack (355), a second rack (360), a first spring (365), a second spring (375), a first rotational mechanism (370) and a second rotational mechanism (380).

FIG. 3 depicts the antenna system (300) with an underside view in the deployed configuration. The rotational damper (350) is attached to the pinion (not shown) and controls the speed at which the antenna elements are deployed, ensuring a smooth and simultaneous deployment of the antenna elements.

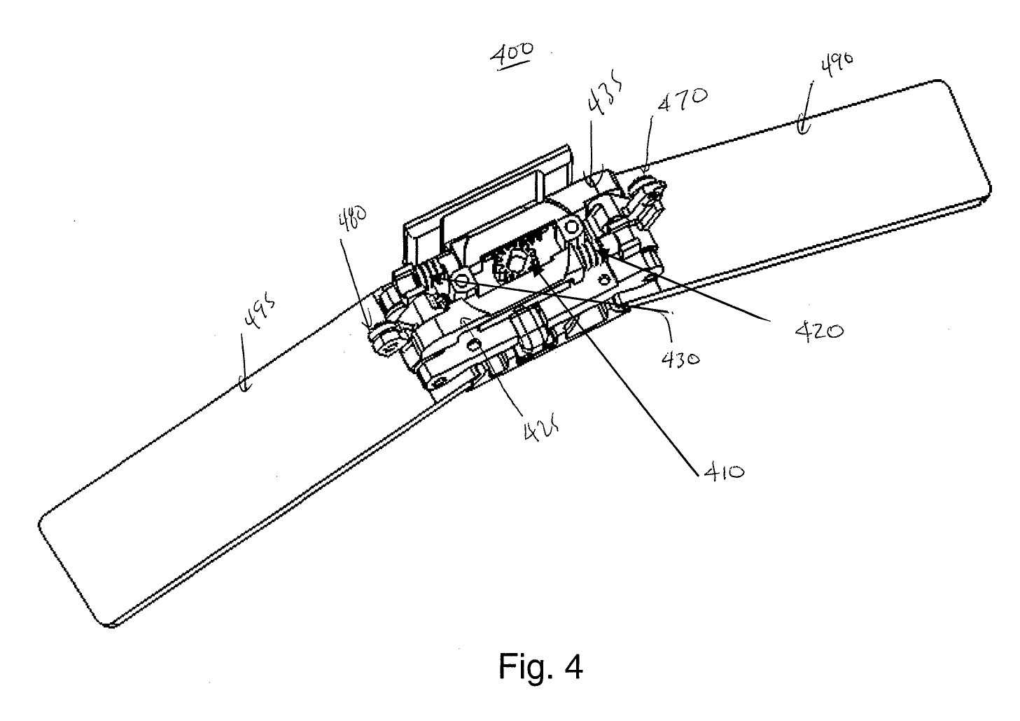

Referring to FIG. 4, a cutaway view of an exemplary embodiment of an antenna deployment mechanism (400) according to the present invention is shown. FIG. 4 shows a pinion (410), a first rack (420), a second rack (430), a first rotational mechanism (470) and a second rotational mechanism (480).

FIG. 4 depicts the antenna system (400) with the rotational damper removed for clarity. Once the actuation button is depressed, the pinion (410) is released. The first spring (420) biases the first rack (425) and the second spring (430) biases the second rack (435). The movement of the first and second racks (425, 435) are synchronized by the pinion (410) which engages teeth in both the first and second racks (425, 435). The speed at which the pinion rotates is controlled by the rotational damper (350 of FIG. 3).

As the first and second racks (425, 435) are biased, they in turn bias the first rotational mechanism (470) and the second rotational mechanism (480). The rotational mechanisms (470, 480) are each attached to a respective antenna element (490, 495). As the rotational mechanisms (470, 480) are biased, an upward bias is applied to the antenna elements (490, 495), thereby rotating them around a first axis and a second axis respectively. The antenna elements (490, 495) are rotated around their respective axis' until they reach a predetermined deployment configuration. A mechanical stop (not shown) can be used to stop the rotation of either the pinion (410), the rotational mechanisms (470, 480), or the antenna elements (490, 495) once the predetermined deployment configuration is achieved.

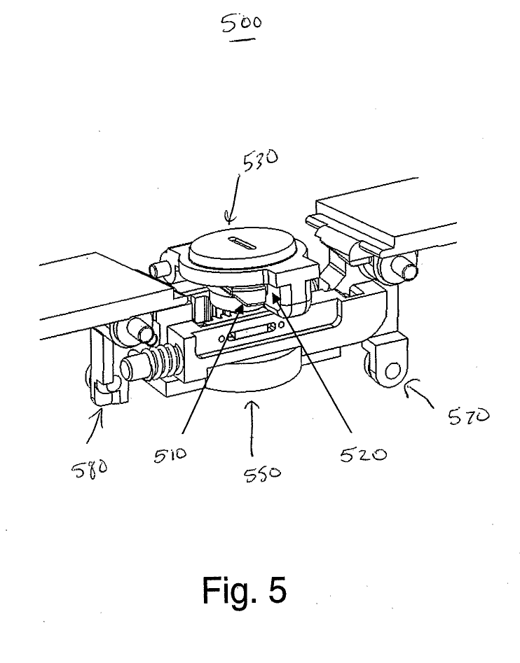

Referring to FIG. 5, a cutaway view of an exemplary embodiment of a release mechanism (500) for antenna deployment according to the present invention is shown. FIG. 5 shows a pinion (510), a stop (520), an actuation button (530), a rotary damper (550), a first rotational mechanism (570) and a second rotational mechanism (580).

Once the actuation button (530) is pushed by a user, the pinion (510) a stop (520) from obstructing the pinion from rotating, and the antenna elements are deployed as described previously. In this exemplary embodiment, the pinion (510) is supported from beneath by a button spring (not shown). When the actuation button (530) is depressed, overcoming the button spring, the stop (520) is moved clear of the pinion, permitting the system to be driven open by the antenna springs.

In an exemplary embodiment, the antenna system (500) can be configured such that one, or both, of the rotational mechanisms (570, 580) are positioned, such that during the deployment operation, a power switch (not shown) is actuated by the moving rotational mechanism. Therefore, turning on the portable television signal processing device by depressing the actuation button (530) powers on the product. When the antenna elements are manually returned to the retracted configuration, the product can be configured such that one, or both, of the rotational mechanisms (570, 580) are positioned such that power switch can once again be actuated and returned to its original, off, state by the moving rotational mechanism. Therefore, manually returning the antennas to the retracted configuration turns of the portable television

1. Apparatus comprising:
a first mechanism supporting a first antenna rotatably in a first rotation direction centering around a first axis;
a second mechanism supporting a second antenna rotatably in the a second rotation direction centering around a second axis arranged parallel to said first axis; and
a third mechanism coupled to said first mechanism and said second mechanism to simultaneously rotate said first antenna and said second antenna.

2. The apparatus of claim 1 wherein said third mecahnism comprises a rack and pinion system.

3. The apparatus of claim 1 wherein said third mechanism comprises a compressible spring and a manual release mechanism and wherein said manual release mechanism comprises a device maintaining said compressible spring in a compressed state and being responsive to an activation by a user to selectively release said compressible spring from said compressed state.

4. The apparatus of claim 3 further comprising a power switch having an on state and an off state, wherein said device changes the state of the power switch in response to activation by the user.

5. A method of deploying an antenna comprising the steps of:
receiving a request to deploy the antenna;
releasing a spring from a compressed state responsive to the request;
simultaneously rotating a first element of the antenna around a first axis and a second element of the antenna around a second axis responsive to the spring being released from the compressed state; and
stopping the rotation of the first and second elements of the antenna responsive to the first and second elements of the antenna being positioned in respective locations.

6. The method of claim 5 wherein said wherein the step of releasing a spring from a compressed state further comprises a step of actuating a power switch.

7. A television signal processing device comprising:
a first antenna element comprising a first rotation mechanism supporting said first antenna element rotatably in a first rotation direction centering around a first axis;
a first rack for biasing said first rotational mechanism, thereby rotating said first antenna element in said first rotational direction around said first axis, wherein said first rack comprises a first compressible spring;
a second antenna element comprising a second rotation mechanism supporting a second antenna rotatably in a second rotation direction centering around a second axis;
a second rack for biasing said second rotational mechanism, thereby rotating said second antenna element in said second rotational direction around said second axis, wherein said second rack comprises a second compressible spring;
a rotational damping means; and
a pinion simultaneously engaging said first rack and said second rack, wherein said pinion is connected to said rotational damping means such that the speed of rotation of said pinion is controlled in response to the rotation of said rotational damping means.

8. The television signal processing device of claim 7 further comprising a manual release mechanism, said manual release mechanism having means for maintaining said first compressible spring and said second compressible spring in a compressed state and having means for selectively releasing said first compressible spring and said second compressible spring.

9. The television signal processing device of claim 8 further comprising a power switch having an on state and an off state, wherein manual release mechanism further comprises a means for changing the state of said power switch.

10. The television signal processing device of claim 8 further comprising a power switch having an on state and an off state, wherein first rotation mechanism further comprises a means for changing the state of said power switch.

11. Apparatus comprising:
a means for rotating a first antenna element in a first rotation direction centering around a first axis;
a means for rotating a second antenna element in a second rotation direction centering around a second axis;
a means for maintaining the simultaneous deployment of said first antenna element and said second antenna element;
a means for controlling the speed of said rotation of said first antenna element and said second antenna element; and
a means for selectively initiating the simultaneous deployment of said first antenna element and said second antenna element.

12. The apparatus of claim 11 further comprising a means for changing the state of a power switch in response to the means for selectively initiating the simultaneous deployment of said first antenna element and said second antenna element.
